(19) United States
(12) Patent Application Publication
(10) Pub. No.: US 2025/0011108 A1
(43) Pub. Date: Jan. 9, 2025

(54) FEEDBACK CONTROL LOOP FOR PNEUMATIC CONVEYING

(71) Applicant: Schenck Process Europe GmbH, Darmstadt (DE)

(72) Inventors: Michael BRADLEY, Greenwich (GB); Richard ELLIS, Doncaster (GB); Tong DENG, Greenwich (GB); Amid KUMAR, Doncaster (GB)

(73) Assignee: Schenck Process Europe GmbH, Darmstadt (DE)

(21) Appl. No.: 18/892,319

(22) Filed: Sep. 20, 2024

Related U.S. Application Data
(63) Continuation of application No. PCT/EP2023/056848, filed on Mar. 17, 2023.

(30) Foreign Application Priority Data
Mar. 21, 2022 (GB) 2203912.7

(51) Int. Cl. B65G 53/66

(52) U.S. Cl. CPC B65G 53/66

(57) ABSTRACT

A pneumatic conveying system for conveying bulk material, the system comprising: an adjustable pneumatic gas flow connected to a pipeline, the pipeline being suitable for conveying bulk material; a measurement device for measuring the variability of particle velocity of a bulk material being conveyed through the pipeline; and a control apparatus, operatively connected to the adjustable pneumatic gas flow and the measurement device; wherein in use, the measurement device outputs the variability of velocity data to the control apparatus. The control apparatus analyses the variability of velocity data, and regulates the rate of the pneumatic gas flow based on the analysis of the variability of velocity data.

This nonprovisional application is a continuation of International Application No. PCT/EP2023/056848, which was filed on Mar. 17, 2023, and which claims priority to Great Britain Patent Application No. 2203912.7, which was filed on Mar. 21, 2022, and which are both herein incorporated by reference.

### BACKGROUND OF THE INVENTION

### Field of the Invention

The present invention relates to a feedback control apparatus, for controlling the gas flowrate in a pneumatic conveying system. Specifically, the feedback control apparatus measures the parameters of a bulk material being conveyed within a pneumatic conveying system, analyses this measured data, and uses the analyzed data to adjust the rate of a pneumatic gas flow that is used to transport particulate material through a conduit. The feedback control apparatus allows the pneumatic conveying system to run more efficiently, by ensuring the particles are conveyed at or close to their minimum conveying velocity, even if this velocity changes over time.

### Description of the Background Art

Pneumatic conveying is a means of conveying a variety of bulk materials in the form of powder, particulate etc. materials through a closed pipeline, by using a transportation gas. The gas is used to carry and convey the materials through the pipeline. These systems are widely used in process industries, such as power plants, pharmaceutical, chemical, cement, food industries etc. There are many examples of successfully conveying a wide range of materials (fine powders to large lumps). Bulk materials may be any form of material which can be conveyed via a pneumatic pipeline, such as fuels, foods, cement dust or powder, pharmaceutical products, quarry materials, rocks, chips, dusts etc. Pneumatic gas conveying is usually carried out with air as the conveying gas, however any suitable gas, for example nitrogen, argon or CO2 may also be used.

In simple terms, the conveying gas in the pneumatic line transports the particulates at a certain velocity. The speed of the conveying gas is usually higher than the speed of the particulates, due to various physical effects which cause the particles to ‘lag’ behind the gas velocity. If the speed of the conveying gas drops below a threshold speed (the minimum conveying velocity or MCV), the particulates can no longer be conveyed in a steady-state way or reliable way. The minimum conveying velocity varies and is dependent primarily upon the material characteristics and the phase of conveying. These phases are typically referred to as lean phase, dilute phase or dense phase in the art. In the case of dilute phase or lean phase, the particles of material are largely suspended in the carrier gas although some may be in dunes or a bed from time to time. In the case of dense phase, the material forms into more significant accumulations of material (commonly referred to as plugs or slugs) which are not fully suspended, but which are either permeable enough for the carrier gas to pass through, or sufficiently air-retentive to remain movable by the air flow. These are sometimes known as “low-velocity slug flow” and “fluidized dense phase” respectively, but there are many different names and sub-categories identified, and there is often not a sharp distinction between lean and dense phase flow. The resulting pressure drop from air acting on either suspended particles, dunes, slugs, plugs or other assemblies of particles creates a force to push the material through the pipeline. The minimum conveying velocity for lean phase conveying is higher than the minimum conveying velocity for dense phase conveying. Materials that support both modes of flow, can therefore have two minimum conveying velocities. The minimum conveying velocity can change with the material or flow parameters (e.g. pipe size and orientation, air density, gas etc.) changes, however the present invention is conceived to operate with either kind of minimum conveying velocity and respond to its variation.

The flow of conveying gas flow through the pipeline can be provided by a pressurized source which is connected to the start of the pipeline, typically referred to as positive pressure. The flow of gaspipeline, topipeline can also be created by lowering the pressure at the end of the pipeline by creating a vacuum (using a pump typically referred to as an exhauster), and therefore allowing the difference between the (atmospheric) pressure at the start of the pipeline, and the exhausted partial vacuum at the end of the pipeline, to create the necessary conveying gas flow which subsequently can transport the material. This arrangement is often referred to as negative pressure or vacuum conveying. There also exists other conditions where the pressure difference required for conveying, between the start and the end of the pipeline, can be created by lowering the pressure at the end of the pipeline relative to the start of the pipeline, but where both the start of the pipeline and the end of the pipeline are both either above or below atmospheric pressure, or one above and the other below. These arrangements do not have accepted terminology in the current art, but are intended to be within the scope of this patent.

Determining the actual MCV for a given material is not a simple task. In addition to the phase of conveying, the MCV value depends on, inter alia, the material properties, pipeline size, pipeline layout, pipeline characteristics and layout of the plant. The minimum conveying velocity (MCV) is therefore always empirically established using conveying tests and experiments, with the minimum velocity identified by a practitioner skilled in the art of recognizing when conveying is suitably reliable or stable considering the phase of conveying. Stable in the sense of the practitioner usually means that the conveying pressure differential across the conveying pipeline does not increase or decrease excessively once a certain steady state mass flow of material and air is established, and that material does not continuously accumulate in the pipeline eventually leading to a blockage. By describing an accumulation, it is intended to describe a situation where the quantity of material feeding into the start of the pipeline exceeds the quantity of material that travels through and leaves the pipeline, eventually resulting in a blockage once the accumulation exceeds a critical point.

An important point to note is that materials nominally of the same type, can require different minimum conveying velocities due to the phase of conveying, variation in particle size, density and shape, and the operating conditions within the pneumatic conveying system. This means that within a practical system designed for a certain material, changes in the minimum conveying velocity can occur if the material properties change, which can lead to blockages and unreliability.

In order to take account of these changes, which can both increase and decrease the minimum conveying velocity, it is typical in the field to add a safety factor to the minimum conveying velocity (or equivalently the total air volume entering the pipeline) to arrive at the design operating condition, in order to avoid material accumulating in the pipeline during periods of changes in material, characteristics and eventually leading to a blockage. Typically, this safety factor is of the order 15-30%, 10-20%, 20-50% depending on the expected variability of the material.

The prior art has proposed different empirical and analytical models to determine the MCV, however, these models have been found to be highly inaccurate, giving results often an order of magnitude in error. Hence, there is no universal model which can predict MCV accurately for any material and pipeline layout, and this is often dependent on the skill of the expert practitioner who uses a combination of information to make the assessment, for example, conveying pressure trends, visual observation of clear sections of pipeline, listening to the noise the pipeline makes, the consistency of material conveying rate. The practice of adding a safety factor to the minimum conveying velocity or conveying air volume results in energy consumption being higher than theoretically necessary, in order to provide robustness against material that arrives at the conveying system and needs to be conveyed (even temporarily) at a higher conveying velocity.

There is therefore a need to establish objectively, rather than from the skill of the operator or by gross safety factors, how close the conveying condition is to what may be a continuously changing MCV, and to use this method to adjust continuously, semi continuously or discretely the actual conveying velocity required to transport the particulate material, with such adjustments to the particle velocity being achieved by varying the volume or velocity of the conveying gas used.

The opportunity to save power consumption by conveying closer to the minimum velocity occurs in two ways. The first saving occurs from reducing the total volume of conveying gas, for which there is an approximately proportional relationship to power. The second is to reduce the conveying pressure by reducing the velocity, for which there is a non-linear relationship. Overall, it is expected that typically a 20% reduction in conveying velocity reduces the power consumption by 30%, for the purposes of simple explanation. However, in practice the relationship is more complex due to temperature and compression efficiency effects and therefore likely to be in the range 20% to 40%.

For the above reasons, there remains a need to address or mitigate at least one or more of the aforementioned problems.

### SUMMARY OF THE INVENTION

It is therefore an object of the present invention to provide an improved apparatus and method for pneumatically conveying bulk material.

It is a further object of at least one aspect of the present invention to provide an improved apparatus and method for a feedback loop in the control of the gas flow and conveying velocity in a pneumatic conveying pipeline.

It is a further object of at least one aspect of the present invention to provide a sensor, a measurement device and a control apparatus, suitable for a pneumatic conveying system for conveying bulk material, wherein the sensor, device and the apparatus work together to regulate the rate of a pneumatic gas flow, based on a real time analysis of the velocity behavior of the bulk material being conveyed.

It is a further object of the present invention to provide a system for use with a pneumatic conveying apparatus, which automatically maintains a pneumatic gas velocity above a constant or variable minimum conveying velocity, thereby preventing conveyed material from continuously accumulating in the pipeline, which may eventually lead to a blockage as previously described.

According to a first aspect of the present invention there is provided a pneumatic conveying system for conveying bulk material, the system comprising: an adjustable pneumatic gas flow connected to a pipeline, the pipeline being suitable for conveying bulk material; a measurement device for measuring the particle velocity of a bulk material being conveyed through the pipeline; a computational processing device to determine the variability or fluctuation in the particle velocity of the bulk material being conveying; and a control apparatus, operatively connected to the adjustable pneumatic gas flow and the measurement and the computational processing device, wherein in use, the measurement device outputs velocity data to the computational processing unit which outputs a signal to the control apparatus, wherein the apparatus analyses the variability of the material velocity in order to regulate the rate of the pneumatic gas flow, in order to achieve an acceptably low fluctuation or variation in the material particle velocity.

Generally, the present invention relates to a pneumatic conveying system for conveying bulk material which is capable of measuring and/or detecting particle velocity fluctuation and variation from conveyed bulk material and adjusting the rate of a pneumatic gas flow to prevent any form of blockage forming, and to minimize the energy consumption by keeping the material conveying velocity at or close to the lowest point possible for the phase of flow used, as indicated by the particle velocity fluctuation. This may be performed using a feedback control, comparing a measure of the actual fluctuation to a set point representing the maximum desirable fluctuation.

The bulk materials being conveyed in the present invention may be any form of powder and/or particulate and/or granular material. In particular, the bulk materials pneumatically conveyed in the present invention may be any of the following: fuels; foodstuff; cement dust or powder; pharmaceutical products; quarry materials; rocks; chips; dusts etc.

One of the benefits of the system is a reduced energy consumption due to the reduction in gas volumetric flow and correspondingly lower conveying velocity. Furthermore, since the measurement device is constantly, or frequently, monitoring the degree of material particle velocity fluctuation, the system should not experience any material conveying pipeline blockages as systems in the prior art often do when the properties of the particulate material change.

As the conveying velocity used in practice in the present invention is lower than the systems in the prior art, the particles being conveyed experience less breakages and/or damage, resulting in a higher quality product for an end user. Similarly, if the conveying velocity is lower, the impact or erosive damage caused to the pipeline and bends will also be lower, reducing wear and extending the life of the conveying components. This is an additional benefit of the present invention to the end user.

The adjusted rate of the pneumatic gas flow may no longer be determined by the gas velocity, but by the bulk material particle velocity and further the variation and/or fluctuation in the material particle velocity. The material particle velocity may be determined in real-time or of, for example, over time periods of about 0.1 s, 1 s, 5 s, 10 s, 60 s. The particle velocity fluctuation or variation may be determined in real time or of, for example, over time periods of about 1 s, 5 s, 10 s, 60 s. This may allow an advantageous control point to be continuously set and varied for the pneumatic gas flow.

The control point in the set velocity is therefore no longer determined by the gas velocity, but the bulk material particle velocity and further the variation and/or fluctuation in the material particle velocity.

When the variation or fluctuation of bulk material velocity reaches an acceptably low value, which can occur at any point in a velocity range of about 1 to 10, 2 to 20, 5 to 50 m/s etc., the control system can automatically change and/or adjust the pneumatic gas volume flow required for conveying, in order to achieve the required material particle velocity at which particle velocity variation is below a predefined limit or set point, and/or the total pipeline pressure drop is minimized. This process can be frequently updated, thereby regulating and/or minimizing the flowrate and/or energy usage of the system.

The invention itself combines methods of particle velocity measurement, for example time of flight sensors based on electrostatic charge detection, or capacitance or inductive principles for mass detection; or electromagnetic Doppler shift sensors for example microwave technology; and processing the signal using known methods such as but not limited to relative standard deviations, Hilbert Huang transforms, wavelet analysis, Kalman filtering, and PID loops in order to adjust the air volume flowrate and/or velocity to that required to achieve the desired level of variation in particle velocity.

The system may be a closed-loop feedback control system. The system may measure and/or analyze in real-time the particle/bulk material velocity and/or velocity variation. The system may measure and/or analyze at a set frequency, for example at around ten times per second, or two times per second, or every three seconds. The frequency that the control apparatus updates the rate of the pneumatic gas flow may also be around ten times per second, or two times per second, or every three seconds. The system may be updated at any other frequency which is appropriate for the application.

For example, some applications may have materials which have significant ‘lag’ or ‘inertia’, and therefore do not respond quickly to pneumatic gas flow changes. Systems in these applications may be updated less frequently. Conversely, systems which have bulk materials which respond quickly to pneumatic gas flow changes may be updated more frequently.

The update frequency values given above are merely exemplary, and should not be construed to be limiting. The skilled person in the art will easily understand how the frequency of updating the system will depend on a number of factors.

The pipeline used may be any diameter which is suitable for conveying the bulk material. The pipeline may change diameter along the length of the system. The pipeline may have various bends and/or orientations, the layout of which is often dictated by the warehouse or industrial plant layout constraints for example.

The system may allow the amount of gas used in the pneumatic conveying system to be adjusted automatically, by reacting to the bulk material flow variations detected by the measurement device. This may be a real-time adjustment process, or there may be a delay due to operational parameters.

The adjustable pneumatic gas flow may be capable of adjusting the velocities of the conveying gas and the material particles within the pipeline, which will also change the pressure in the pipeline as a result in the change in total mass flow rate. The mass flowrate, the volume flowrate, the velocity, may be adjusted and/or controlled, with a consequent change on the pressure.

By determining the gas velocity or conveying gas volume point at which the particle velocity fluctuation starts to increase, the minimum reliable particle velocity and gas velocity can be determined in real time, for any particulate solid material that could be conveyed. This is an advantage of the present invention over the systems according to the prior art.

The total conveying pressure may also be measured and included in the signal processing, as the point of minimum power consumption can also be dynamically calculated because the required power consumption is a function of the gas flow volume and total pipeline pressure loss. This results in a system which can adjust the pneumatic conveying velocity depending on the individual system needs and requirements, for example minimum reliable conveying velocity, minimum power consumption, and very often both.

The adjustable pneumatic gas flow may be a positive displacement pump or a compressor if connected to the inlet of the conveying pipeline; or a negative displacement pump or exhauster if connected to the outlet of the conveying pipeline. The adjustable pneumatic gas flow may be any other form of energy supply and/or flowrate controller. The adjustable pneumatic gas flow may be a flow control valve, or a variable speed compressor, or variable speed pump, or variable speed exhauster. It may also be a fluid dynamic device such as an ejector, injector, eductor, aspirator, jet pump or other device that uses a primary flow of gas or liquid to induce a secondary flow. The adjustable pneumatic gas flow may also be a valve and or regulator, which regulates the velocity from a gas flow or gas pressure supply. For example, a high velocity gas pipeline may join onto the main pneumatic gas flow, and a valve may be partially opened to adjust the flowrate into or out of the apparatus.

The measurement device may measure the material velocity and velocity variability of the bulk material being conveyed by measuring the bulk materials' electrical charge. There may be a stepwise process for measuring the velocity variability of the bulk material. For example, the process may be as follows:

Measure the velocity of the material, and within a time domain of, for example 0.1 to 1, 1 to 5, 2 to 10 seconds use traditional or novel mathematical or statistical techniques to determine the variability of the signal. Such mathematical techniques could include standard deviation, relative standard deviation, Fourier transform, Hilbert Huang frequency domain analysis, wavelet transform, Kalman filtering, etc. All such measures include factors related to variability.

This process may be used to produce a variability measurement of the bulk material. The variability measurement may be a dimensionless number, as typically produced by most statistical or analytical methods, for example relative standard deviation.

The velocity may be measured by any suitable device. The velocity data, captured by the measurement device, may then be passed on to the control apparatus, wherein the control apparatus analyses the measurement data. The analyzed data may then be used to adjust the volume and/or mass flowrate of the pneumatic conveying gas, until the level of particle velocity fluctuation is below a set point indicative of reliable conveying.

The set point may be determined theoretically, or it may be determined empirically, by using the measurement device. Alternatively, any other suitable measurement apparatus or device may be used to determine the set point. Typically, the set point is the point at which the particle velocity variability is decreased to a level which indicates a desirable flow condition, after which further significant reductions in particle variability cannot be reliably achieved within the chosen phase of operation.

The measurement device may be one of an electrostatic sensor, a capacitance sensor, and/or a microwave or Doppler shift sensor, and/or a vibration sensor, and/or an audio sensor, and/or an optical sensor. The measurement device may be any suitable sensor for measuring parameters of a bulk material being conveyed.

The measurement device may comprise at least one electrostatic (or other) sensor, and wherein at least one electrostatic (or other) sensor may comprise a plurality of arc or ring or pin shaped electrodes or measurement zones. The electrodes or measurement zones may be any shape suitable for a pipeline or conduit. The pipeline or conduit may have a circular or square or rectangular or other cross-sectional geometry. The sensor may comprise a plurality of different shaped electrodes or sensors or measurement zones, suitable for the pipeline or conduit in use.

In use, the plurality of sensors may comprise a first and second sensor. Each sensor may be located on the bottom of the pipeline, the top of the pipeline, the side of the pipeline, or other suitable arrangements for a conduit. The sensors may be located at any orientation around the pipeline, to capture particle velocity data in certain areas of the pipeline cross section. The bottom of the pipeline can be anywhere below a horizontal plane, bisecting the pipeline. The top of the pipeline can be anywhere above a horizontal plane, bisecting the pipeline.

Comparing the signal from the first and second sensor, provides a time of particulate material flight between the two sensors, which when the distance between the two sensors is known, allows for the calculation of a velocity. Similarly measuring the Doppler shift of returned electromagnetic waves can also provide the calculation basis for velocity. By measuring the velocity over several sampling periods, information about the variation in velocity can be obtained.

The effectiveness of the velocity measurement may be further enhanced by separately measuring the velocity in the lower part of a horizontal pipe, the upper part of the pipeline, or any segment around the pipeline cross sectional area, and processing the signals independently or dependently to ensure the set points for velocity variation are achieved under varying pipeline operating conditions.

A method to measure within a certain area within the pipeline is an arc shaped electrostatic sensor.

The arc angle of the arc shaped electrostatic sensors may be around any angle which creates an arc, for example around about 10 to 30 degrees, about 30 to 60 degrees, about 60 to 90 degrees, about 90 to 120 degrees, 110 to 130 degrees or about 120 to 150 degrees.

The control apparatus may maintain the velocity of the pneumatic gas above the MCV and also at a set point indicative of acceptable material velocity fluctuation, by continuously analyzing the variability data, and updating the control output accordingly. The control apparatus may maintain the velocity of the pneumatic gas in the pipeline above the minimum conveying velocity (MCV) by: about 1-15%; about 5-15%;

about 5-13%; or about 10%, on condition the set point conditions for acceptable velocity variation is achieved.

Depending on the particular characteristics of the system, the velocity of the pneumatic gas may increase to around 120% or more of a minimum conveying velocity. This increase to around 20% or more above the minimum conveying velocity may be required to remove bulk material accumulations in the pipeline, or to destroy any blockages, which could occur during non-steady state conveying.

The system may increase the velocity of the pneumatic gas in the pipeline if the measurement device senses any excessive variability of flow of the bulk material being conveyed. This increase of velocity would usually be a temporary measure, which would be used to clear any undesirable variation in material flow. Once the variation was equal to the set point conditions, the velocity of the pneumatic conveying gas would be decreased again, to save energy and costs.

The relative standard deviation (RSD) of the velocity of the bulk material may be taken from the velocity and velocity variation analysis, and may be used by the control apparatus to regulate the rate of the pneumatic gas flow, to maximize energy efficiency. Other measures also possible such as wavelet analysis, Hilbert Huang, Fourier Transform, etc.

In general terms, RSD can also be defined as a coefficient of variation. RSD is a standardized measure of dispersion of a frequency distribution relative to the mean. In the examples in this description, it is the frequency distribution of particle velocities from time period to time period.

The RSD can be more useful than the ‘standard deviation’ because the standard deviation does not consider the magnitude of the mean of the data. This is in contrast to the RSD, which is a ratio of the standard deviation to the mean, and is a dimensionless number, since it is independent of the unit of measurement.

The particle velocity RSD shows a clear transition from acceptable velocity fluctuation to undesirable velocity fluctuation, at various different flowrates, and is a single control variable in a complex system. This illustrates that using particle velocity RSD is a good indicator to show whether or not the flow is likely to have excessive variability. Furthermore, particle velocity RSD is easy to calculate in a discrete or continuous control system, and is easy to apply for monitoring and controlling purposes, for a pneumatic conveying system.

RSD is only one example, other mathematical or statistical measures can be used, for example Fourier transforms, Hilbert Huang, Wavelet transformation, Kalman etc.

There may be a plurality of measurement devices connected to the pipeline. They may be located at various locations on the pipeline. The measurement devices may be fixed to the pipeline. Alternatively, the measurement devices may be removable from the pipeline.

According to a further aspect of the present invention, there is provided a pneumatic conveying system for conveying bulk material, the system comprising: an adjustable pneumatic gas flow connected to a pipeline, the pipeline being suitable for conveying bulk material; a measurement device for measuring the stability of a bulk material being conveyed through the pipeline; and a control apparatus, operatively connected to the adjustable pneumatic gas flow and the measurement device; wherein in use, the measurement device outputs velocity variability data to the control apparatus, wherein the control apparatus analyses the velocity variability data, and regulates the rate of the pneumatic gas flow based on the analysis of the data.

Generally, the present invention relates to a pneumatic conveying system for conveying bulk material which is capable of measuring and/or detecting velocity variability data from conveyed bulk material and adjusting the rate of a pneumatic gas flow to prevent any form of blockages forming. This may be performed using a feedback control.

Measuring the particle velocity variability of the particulate flow may involve measuring the velocity of the bulk material being conveyed. The velocity variability data may be comprised of any number of variables, which can be used to give an indication of the stability of the material flow. For example, if the material properties (velocity, pressure, variations etc.) are diverging, then it is likely that the material is unstable. If the material properties are converging, then it is likely that the material is stable. The stability data will therefore give an indication of the general trend of the bulk material's properties.

According to a further aspect of the present invention there is provided a feedback control apparatus, configured for use with a pneumatic conveying system for conveying bulk material, the feedback control apparatus comprising: a measurement device, configured to be attachable to a pipeline within the pneumatic conveying system, wherein the measurement device is capable of measuring the particle velocity of a bulk material being conveyed; an analytical device, capable of using the particle velocity measurement data and calculating the variability of the velocity from time period to time period. a control apparatus, configured to receive the velocity variability calculation, compare this to the required variability set point, and control the rate of an adjustable gas flow.

The feedback control apparatus may incorporate and use any of the other features described herein.

The control apparatus may maintain the velocity of the pneumatic gas in the pipeline within an acceptable margin of a minimum conveying velocity, by continuously analyzing the particle velocity variability, and updating the control output accordingly.

According to further aspect of the present invention there is provided a method of controlling and/or regulating the flowrate of a pneumatic conveying gas in a pneumatic conveying system for conveying bulk material, the system comprising a pipeline, an adjustable gas flow connected to the pipeline, a control apparatus, and a measurement device, the method comprising: measuring the variability of a bulk material being conveyed in the pipeline using the measurement device, and outputting data to the control apparatus; analyzing the particle velocity variability data with the control apparatus, and using this analysis to regulate the rate of the pneumatic gas flow based on the analysis of the particle velocity variability, or stability data.

The method of controlling and/or regulating the flowrate of a pneumatic conveying gas may incorporate and use any of the other features described herein.

The method may be a closed-loop feedback method.

The method may regulate the velocity of the pneumatic gas flow, based on the analysis of particle velocity variability, or stability data.

The velocity of the of the bulk material being conveyed may be measured by measuring the bulk materials' electric charge and time of flight over a known distance between two sensors.

The velocity variability of the bulk material being conveyed may be measured my comparing the velocity in one time period with the velocity in another time period.

Measuring the velocity of the bulk material being conveyed may be done on an upper and/or lower section of the pipeline.

The method may maintain the velocity of the pneumatic gas in the pipeline within about 10% of a minimum conveying velocity, by continuously analyzing the velocity variability, and updating the control output accordingly.

The method may increase the velocity of the pneumatic conveying gas in the pipeline if the velocity variability exceeds a specified setpoint, where the variability of the pipeline is indicative of an accumulation of material in the pipeline which could lead to a blockage.

The measurement device and the control apparatus may be updated a plurality of times per second, resulting in a real-time feedback loop.

The method may use the system as previously described.

According to a further aspect of the present invention there is provided a method of controlling or regulating the flowrate of a pneumatic conveying gas in a pneumatic conveying system for conveying bulk material, the method comprising: measuring the particle velocity of a bulk material being conveyed within the conveying system, analyzing the variation in velocity from one time period to another using the analysis of the velocity variability to control the rate of a pneumatic gas flow connected to the conveying system.

The variability of the particle velocity may be measured by comparing the particle velocity change over a time period, and using statistical measures of variability.

The method may maintain the rate of the pneumatic gas flow above a minimum conveying velocity (MCV), through analyzing the fluctuation of the particle velocity of the bulk material being conveyed.

The method may maintain the velocity of the pneumatic gas in the pipeline within about 1 to 10% of a minimum conveying velocity, by continuously analyzing the particle velocity variation over time and updating the control output accordingly. Alternatively, the control apparatus may maintain the velocity of the pneumatic gas in the pipeline above the minimum conveying velocity (MCV) by: about 1-15%; about 5-15%; or about 5-10%.

The method may be used on the system as previously described.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1a and 1b are pneumatic conveying systems according to an example of the present invention;

FIG. 2 is a pneumatic conveying system according to an example of the present invention similar to FIG. 1 but comprising two measurement devices in the pipeline;

FIG. 3 is pneumatic conveying system according to an example of the present invention showing two measurement devices, located in different positions within the pneumatic conveying system;

FIG. 4 is a 3D model sectional view of an electrostatic sensor which may be used in a further example of the present invention;

FIG. 5 is a 3D model view of a further electrostatic sensor which may be used in an example of the present invention where the sensor comprises arc shaped electrodes;

FIG. 6 is an image showing an example of where electrodes may be located on a pipeline according to an example of the present invention;

FIG. 7 is a graph showing data from stable flow inside a pipeline according to an example of the present invention;

FIG. 8 is a graph showing data from an unstable flow inside a pipeline; and

FIG. 9 is a graph showing the relative standard deviation of particle velocities, according to a method used in an example of the present invention.

### DETAILED DESCRIPTION

Generally speaking, the present invention relates to a pneumatic conveying system for pneumatically conveying bulk material, wherein the system comprises a feedback loop to control the flowrate of the bulk material.

Bulk material may be defined as dry or substantially dry materials which may be in the form of any one of or combination or the following: powder; granular; lumpy etc. Examples of bulk materials may be any one of or combination of the following: any type of foodstuff; minerals; ores; coal; cereals; woodchips; pellets of various materials; cement; sand; gravel; clay; cement; ash; salt; chemicals; grain; sugar; flour and stone in loose bulk form.

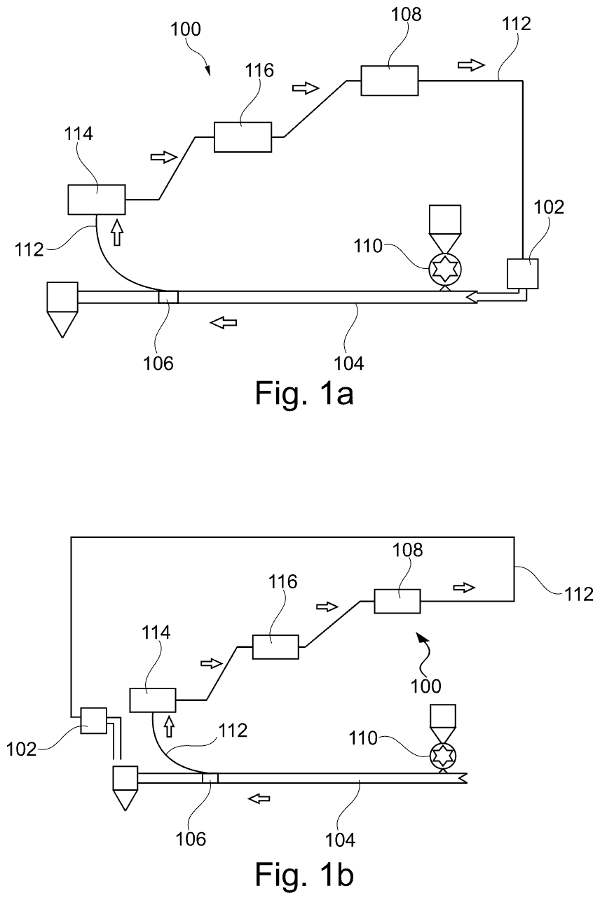

FIGS. 1a and 1b illustrate examples of a pneumatic conveying system 100 according to the present invention. The pneumatic conveying system 100 may be used to pneumatically convey bulk material.

FIG. 1a shows the conveying gas being controlled from the start of the pipeline, while FIG. 1b shows the conveying gas being controlled at the end of the pipeline.

An adjustable pneumatic gas flow 102 is shown connected to a pipeline 104, along with a material feed 110 located downstream of the pneumatic gas flow inlet 102. Located on top of the material feed 110 there is a hopper. It should be noted that any type of feeding mechanism may be used.

In the example shown in FIGS. 1a and 1b, the flow of gas and material is from right to left, however this should not be construed to be limiting.

A measurement device 106 is shown downstream of the pneumatic gas flow 102 and the material feed 110.

The measurement device 106 may be located anywhere on the pipeline 104, and may be fixedly attached to a specific location, or alternatively the measurement device 106 may be removable from the pipeline 104. The measurement device 106 may be located internal to the pipeline 104 or external to the pipeline 104. The measurement device 106 may be retrofitted to existing pipelines.

A feedback control loop 112 is shown, leading from the measurement device 106 to the pneumatic gas flow 102. The feedback control loop 112 may comprise: a measurement device memory module 114; a data processing module 116; and a control apparatus 108. These modules and apparatuses are shown to be separate items in FIG. 1, however this should not be construed to be limiting, but merely exemplary. There may only be one or a plurality of apparatus which combines all of the required steps, such as measurement memory storage, data or signal processing, and output control.

The feedback control loop 112 operates by adjusting the rate of the pneumatic gas flow 102, depending on the measured bulk material parameters measured by the measurement device 106. The feedback control loop 112 may adjust the flowrate periodically such as about every 1-5 seconds. Alternatively, the feedback control loop 112 may adjust the flowrate in real-time.

The aim of the system 100 is to convey bulk materials in an efficient manner, with as little energy wastage as possible, i.e. by maintaining a gas conveying velocity as low as possible. The minimum flowrate desired may therefore be slightly above the minimum conveying velocity (MCV). This is described in more detail below.

As previously described, bulk materials can often block pipelines. The solution to this problem is to increase the velocity of the conveying gas, which will avoid the blockage of bulk material, and ensure conveying.

Any form of bulk materials may be conveyed in a pipeline, such as dusts, powders, pelletized and granulated materials.

The measurement device 106 may be used to measure a number of parameters, such as any one or combination of: bulk material velocity; electrical charge; flowrate etc.

The measurement device 106 may be used to measure bulk material parameters, and/or it may be used to measure gas parameters. Details of example measurement devices 106 will be discussed in greater detail later on.

In use, the adjustable pneumatic gas flow 102 will be set at a constant velocity. Bulk material will be introduced into the system 100, and will be conveyed along the pipeline 104, where it will pass a measurement device 106. The measurement device 106 will measure the bulk material parameters, and through analysis, the feedback loop 112 will be able to determine whether or not the bulk material flow is stable or unstable (based on the particle velocity variability and comparison to the set point for acceptable velocity fluctuation),

For example, if the pipeline 104 has particle velocity variation below the maximum set point value, then the control loop 112 will send a signal to the adjustable pneumatic gas flow 102 to lower the flowrate of the conveying gas. The measurement device 106 may be on a loop to read data every 1-5 seconds for example, and so the measurement device 106 will pick up any differences in the bulk materials' behavior. Alternatively, the measurement device 106 may constantly monitor the flowrate in real-time.

If the particle velocity variability continues to be below the maximum acceptable value, then the feedback control loop 112 will decrease the velocity of the adjustable pneumatic gas flow 102. This process will continue, until the pneumatic conveying system 100 detects the particle velocity variability is equal to or slightly less than the maximum acceptable velocity variation. Slightly less than can be defined by the user and typically will be in the order of 1-10%, 5-15%, 10-30%.

If the velocity variability exceeds the threshold limits, the pneumatic conveying system 100 will then respond to this appropriately by increasing the flowrate of the adjustable pneumatic gas flow 102. The pneumatic conveying system 100 will then seek to maintain a conveying gas flow that maintains the particle velocity variation equal to, or slightly less, than the acceptable value or setpoint. The flowrate of the adjustable pneumatic gas flow 102 may therefore be slightly above the minimum conveying velocity (MCV) of the bulk material. For example, by slightly above the minimum conveying (MCV) may be meant to be: about 5-15%; about 5-13%; about 5-10% above the minimum conveying (MCV).

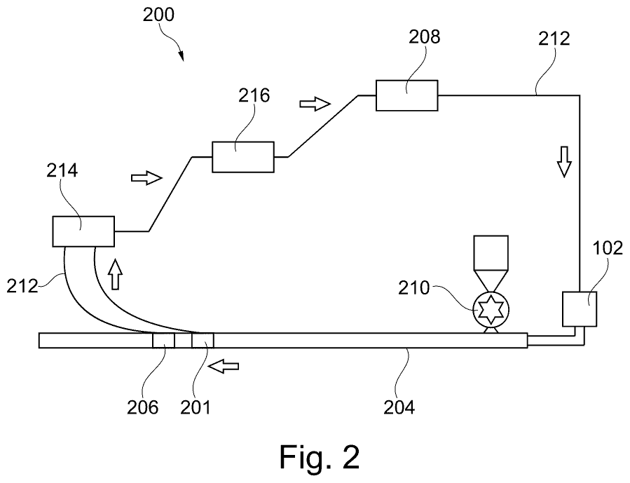

FIG. 2 is an example of a pneumatic conveying system 200 similar to the example shown in FIG. 1. The difference in the pneumatic conveying system 200 is that there is a first measurement device 206 and a second measurement device 207 on a pipeline 204. The measurement devices 206, 207 may be located anywhere on the pipeline 204, and may be fixedly attached to a specific location, or alternatively the measurement devices 206, 207 may be removable from the pipeline 204. The measurement devices 206, 207 may be located internal to the pipeline 204 or external to the pipeline 204. The measurement devices 206, 207 may be retrofitted to existing pipelines.

It should be noted that the pneumatic conveying system described herein may comprise any suitable number of measurement devices such as a plurality of measurement devices. FIGS. 1 and 2 should therefore not be construed as limiting to the scope of the present invention.

The feedback control loop 212 may comprise: a measurement device memory module 214; a data processing module 216; and a control apparatus 208. These modules and apparatuses are shown to be separate items in FIG. 2. However, this should not be construed to be limiting, but merely exemplary. There may only be one or a plurality of apparatus which combines all of the required steps, such as measurement memory storage, data or signal processing, and output control.

The measurement devices 206, 207 may be located close to one another, or spaced far apart. The measurement devices 206, 207 may be separated by about 1-100 cm or about 1-10 cm or about 2-200 cm.

Both measurement devices 206, 207 feed into the same feedback loop 212 as shown, or there may be a plurality of feedback loops which are used.

The adjustable pneumatic gas flow 202 is shown in FIG. 2. However, the gas flow may be located anywhere in the system 200.

The adjustable pneumatic gas flow may be downstream of the measurement devices 206, 207 or the gas flow may be located between a plurality of measurement devices.

There may also be a plurality of gas flows, located throughout the system 200. Each gas flow may be linked to a specific measurement device, or the gas flows may be linked to the central feedback control loop 212. Alternatively, or in combination, they may also be a feedback control loop connected to the material flow 210, which may vary the flowrate of the bulk material to be conveyed into the system.

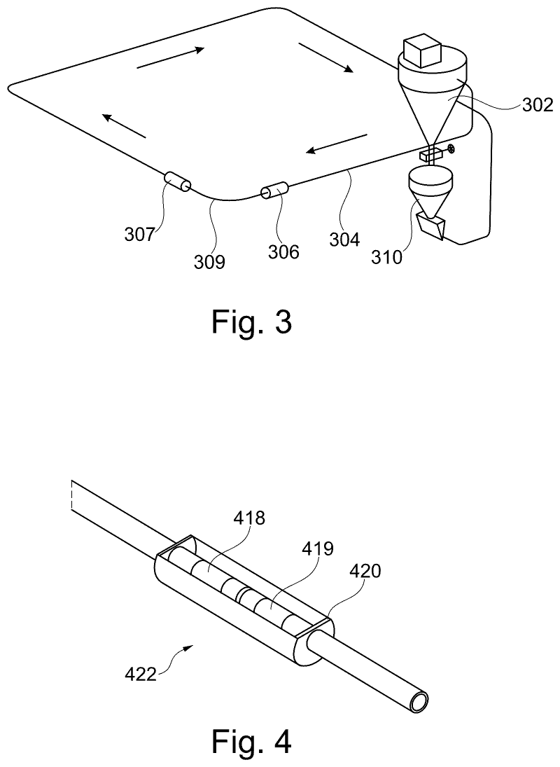

FIG. 3 is an example of part of a further pneumatic conveying system according to the present invention. The pneumatic conveying system comprises a first measurement device 306 and a second measurement device 307. As shown in FIG. 3, the measurement devices 306, 307 are located in different positions within the pneumatic conveying system. The first measurement device 306 is located just before a bend 309 in the pipeline 304. The second measurement device 307 is located after the bend 309 in the pipeline 304.

As in FIGS. 1 and 2, an adjustable pneumatic gas flow is shown, along with a material feed 310, both being connected to a pipeline 304. A hopper 302 is also shown.

It has been found that the measurement devices 306, 307 which are located before and after the bend 309 in the pipeline 304 may be used to monitor the flow characteristic due to the presence of the bend 309.

FIG. 3 further illustrates that measurement devices may be located anywhere in the pneumatic conveying system.

FIG. 4 is a 3D model sectional view of an electrostatic sensor generally designated 422. The electrostatic sensor 422 may be used in the present as a measurement device as previously described. In FIG. 4, the top of the electrostatic sensor 422 has been removed from the sectional view, to show the internal workings of the electrostatic sensor 422.

The electrostatic sensor 122 comprises a metallic screen 420 for shielding ring-shaped electrodes 418, 419 inside the electrostatic sensor 422 from external influences. The screen 320 may be made from any material which prevents the ring-shaped electrodes 418, 419 from picking up erroneous signals.

The example of the electrostatic sensor 422 shown in FIG. 4 comprises two ring-shaped electrodes 418, 419. The ring-shaped electrodes 418, 419 detect particle charges (i.e. positive and/or negative charges), by generating image charges within the electrodes, induced by the presence of charged particles within the pipeline. The particles in the conveyed bulk material in conveying systems carry a charge due to particle-particle interactions, and particle-wall interactions.

The electrostatic sensor 422 picks up these electrostatic charges, and the detected charges can be converted into voltage signals by using known electronics and hardware techniques. If a plurality of electrodes 418, 419 are used, then the velocity of the particles or bulk material can easily be calculated (since a time difference and a distance is known). The velocity of the particles may also be calculated from one electrode if the measurement accuracy is high enough. Any suitable number such as a plurality of electrostatic sensors may be used.

A major advantage with using an electrostatic sensor 422 is that it is a non-invasive technology, and so does not affect the flowrate or flow characteristics inside the pipeline. The electrostatic sensor 422 may also be easily replaced or retrofitted to an existing pneumatic conveying system.

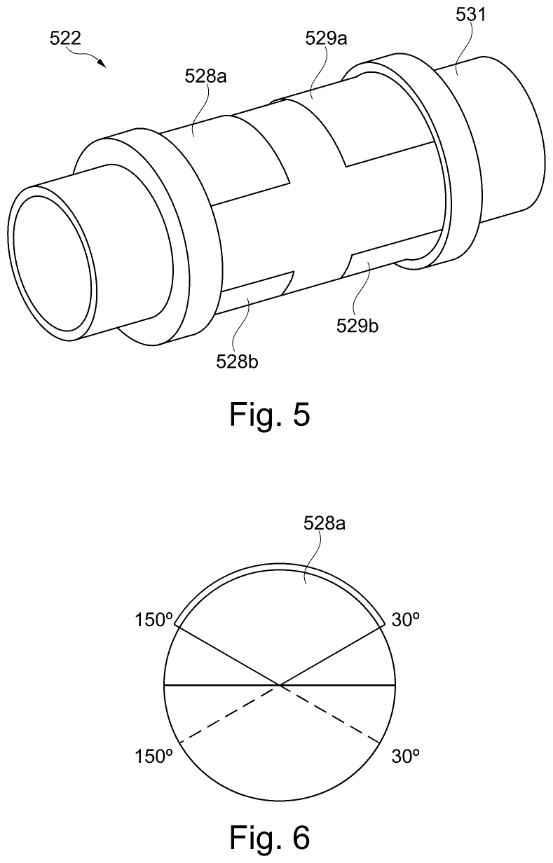

FIG. 5 is a 3D model view of another example of an electrostatic sensor 522 which may be used in the present invention, where the electrostatic sensor 522 comprises four arc shaped electrodes 528a, 528b, 529a, 529b. This is largely the same design as the electrostatic sensor 422 in FIG. 4, however there are four arc shaped electrodes 528a, 528b, 529a, 529b, which cover four quadrants of part of a pipeline 531. As shown in FIG. 5, electrodes 528a, 528b and electrodes 529a, 529b are facing one another.

The arc shaped electrodes 528a, 528b, 529a, 529b have the added advantage over standard ring electrodes 118 in that they can determine the charge of the particles both at the top and bottom of the pipeline 531.

FIG. 6 is an image showing an example of where the electrodes in FIG. 5 may be located. In both FIGS. 5 and 6, the arc angle of each of the electrode 528a, 528b, 529a, 529b is about 120 degrees. This is merely exemplary, and should not be construed to be limiting. The arc angle of the electrodes 528a, 528b, 529a, 529b may be any angle which creates an arc, for example around about 10 to 30 degrees, about 30 to 60 degrees, about 60 to 90 degrees, about 90 to 120 degrees, or about 120 to 150 degrees.

The arc shaped electrodes 528a, 528b, 529a, 529b in FIGS. 5 and 6 are shown to be located on substantially the bottom and on substantially the top of the sensor 522, to measure particle parameters on substantially the bottom of the pipeline 531 and on substantially the top of the pipeline 531 (top and bottom should be understood relative to when the sensor 522 is in use). If required, the arc shaped electrodes 528a, 528b, 529a, 529b may be located at any position around the sensor 522, to measure the particle parameters in the left or right sides of the pipeline 522 for example.

The arc shaped electrodes 528a, 528b, 529a, 529b in the Figures can be made for any diameter pipeline 531, and can be installed permanently or removably. The electrodes 528a, 528b, 529a, 529b may also be retrofitted to existing pipelines.

The arc shaped electrodes 528a, 528b, 529a, 529b can be installed in pairs, or in a single unit. Alternatively, they may be installed in any combination.

The arc shaped electrodes 528a, 528b, 529a, 529b may be of any length. The axial length of the electrodes 528a, 528b, 529a, 529b in FIG. 5 is about 75% of the pipeline's diameter. The length of the arc shaped electrodes 528a, 528b, 529a, 529b may be dependent upon the sensitivity of the measurements. For example, if the length of the electrode 528a, 528b, 529a, 529b is too long, it may pick up electrostatic charges from the opposite side of the pipeline.

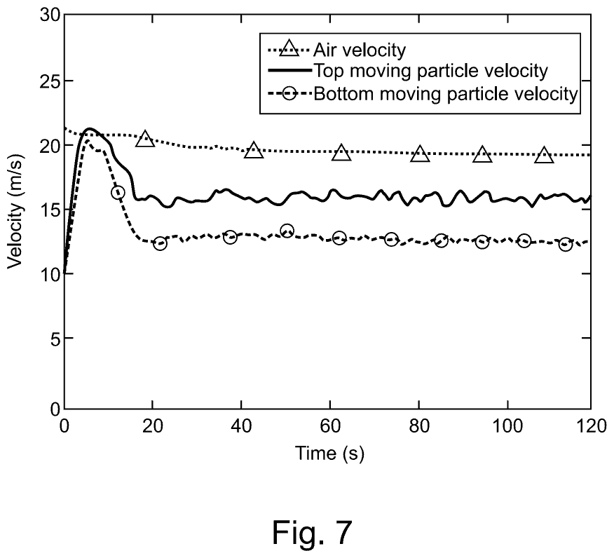

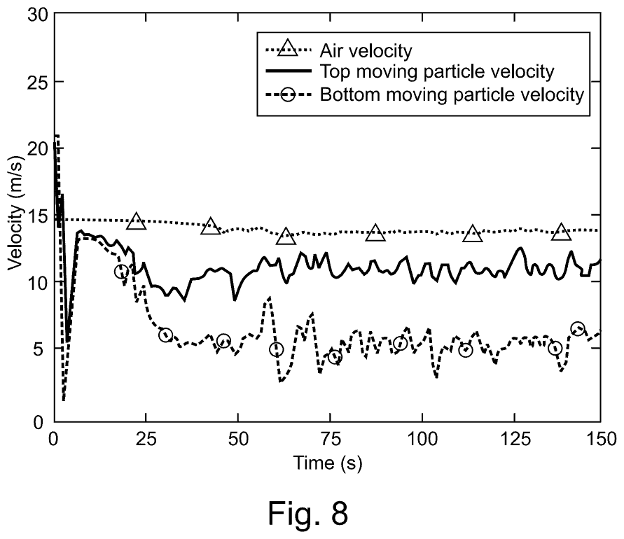

FIG. 7 is a graph showing data from stable bulk material flow inside a pipeline, and FIG. 8 is a graph showing data from unstable bulk material flow inside a pipeline. These graphs are shown to illustrate the differences between stable and unstable flows inside a pipeline, and how this is measured.

Both of the graphs in FIGS. 7 and 8 illustrate the velocity of the pneumatic conveying gas (air in these examples), the velocity of the particles in the bottom of the pipe, and the velocities of the particles in the top section of the pipe.

FIG. 7 shows the stable flow conditions for pneumatically conveying bulk material, where the air velocity is an almost constant 20 m/s. The velocity of the top and bottom particles are generally similar, and are at an almost constant value, 5 m/s slower than the air velocity. As described previously, the particles move slower than the air due to aerodynamic and inertial effects. The velocity of the top particles in the upper part of a pipeline are about 15 m/s. The velocity of the bottom particles in the lower part of the pipeline are about 13 m/s. The speed of the particles is measured in real-time or, alternatively every 1-2 seconds.

We now refer to FIG. 8 which illustrates unstable flow conditions for pneumatically conveyed bulk material. As shown in FIG. 8, the air velocity has been reduced to about 15 m/s which remains substantially constant for 0-150 seconds.

FIG. 8 shows that the velocity of the pneumatically conveyed particles has substantially slowed. The particles in the top of the pipeline have slowed to about 12 m/s and the particles in the bottom of the pipeline have slowed to about 5 m/s. It is also noticeable from FIG. 8 that there is much more noise or variability in the signals and therefore much more fluctuation and variability in the speed of the particles, especially in the bottom of the pipeline.

The particle velocity data in FIG. 8 shows that the particles have slowed down considerably in comparison to the stable flow data shown in FIG. 7. FIG. 8 also shows that the particles also have large fluctuations in velocity in both the top and bottom of the pipeline. These large fluctuations are easily detectable, and are a strong indicator that material may be about to build up in the pipeline, or has already started to build up in the pipeline. This knowledge and analysis can be used to control the system according to the present invention, by increasing the gas velocity when the presence of excessive particle velocity variation is monitored and/or detected.

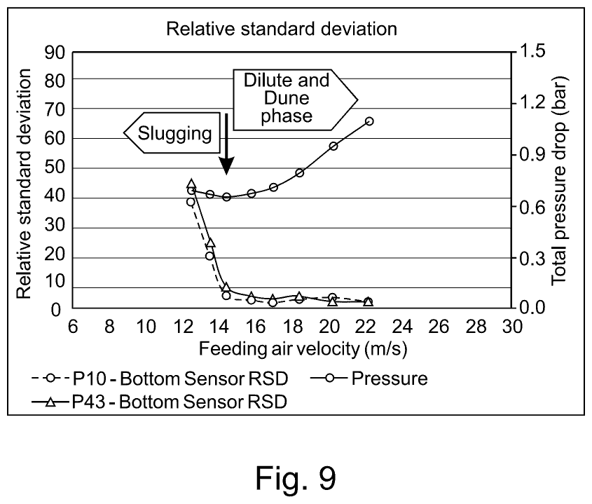

FIG. 9 is a graph showing the relative standard deviation (RSD) of particle velocities, according to a method used in the present invention. The graph shows the relative standard deviation (RSD) of the particle velocity fluctuations, relative to the feeding air velocity. P10 is a sensor near the feeding section, and P43 is a sensor which was closer to the end of the pipeline. The sensors may be as previously described and, in particular, electrostatic sensors. The pressure drop across the pipeline (e.g. from an inlet to an outlet) is also plotted.

The graph in FIG. 9 therefore shows that at high feed air velocities, the relative standard deviation (RSD) is low and constant, and is about 5 on the graph shown. It may be preferred that when locating an ideal velocity of the pneumatic gas flow to prevent any form of blockages the relative standard deviation (RSD) may be about any of the following: about 1%-15%; about 5%-15%; or about 5%-10%.

When the feed air velocity gets to a certain low level, the RSD of the particle velocities starts to rise abruptly, as shown at around 14 m/s in FIG. 9. As illustrated, blockages may begin to form anywhere below 14 m/s in this particular setup, whereas above 14 m/s, conveying is stable.

One such way of analyzing the behavior of the particles/bulk materials is to use the relative standard deviation (RSD). As previously stated, the fluctuations in the particle velocities are measured via the measurement device.

In general terms, RSD can also be defined as a coefficient of variation. RSD is a standardized measure of dispersion of a frequency distribution. In the examples in this description, it is the frequency distribution of particle velocities.

The RSD can be more useful than the ‘standard deviation’ because the standard deviation must always be understood in terms of the mean of the data. This is in contrast to the RSD, which is a dimensionless number, since it is independent of the unit of measurement.

The magnitude of the velocity fluctuations may be calculated via a statistical tool, such as RSD. The different measurement devices may capture average particle velocity, and average particle velocity RSD.

The particle velocity RSD shows a clear transition from stable to unstable, at various different flowrates. This illustrates that using particle velocity RSD is a good indicator to show whether or not the gas flow and particle velocity is too low and is likely to be too low and start to form blockages. Furthermore, particle velocity RSD is easy to calculate, and is easy to apply for monitoring and controlling purposes, for a pneumatic conveying system.

The graph in FIG. 9 illustrates the analysis the system will carry out to determine what the velocity of the pneumatic gas flow should be. Ideally, the system will maintain a velocity just above the minimum velocity (i.e. below which blockages may start to form). In the example shown in FIG. 9, this velocity was found to be just above 14 m/s). This will provide a system which does not start to block up and will maintain a clear pipe, with effective material transport, all whilst using the minimum amount of energy. Of course, each pipe and system is different, depending on pipe diameter, material blown, geometry of the pipework etc. This will lead to differing minimum conveying velocities.

Although FIG. 9 has shown that RSD can be used to predict when instability may start to occur, any other form of suitable statistical analysis may be carried out, to determine the minimum conveying velocity.

Whilst specific examples of the present invention have been described above, it will be appreciated that departures from the described examples may still fall within the scope of the present invention. For example, any suitable type of sensor may be used to detect and/or measure the velocity of the pneumatically conveyed bulk material.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A pneumatic conveying system for conveying bulk material, the system comprising:
an adjustable pneumatic gas flow connected to a pipeline, the pipeline being suitable for conveying bulk material;
a measurement device for measuring the particle velocity of a bulk material being conveyed through the pipeline; and
a control apparatus, operatively connected to the adjustable pneumatic gas flow and the measurement device,
wherein the measurement device outputs the data to calculate the velocity to the control apparatus, and
wherein the control apparatus calculates the particle velocity and analyses the variability of particle velocity data, and regulates the rate of the pneumatic gas flow based on the analysis of the variability of particle velocity data.

2. The pneumatic conveying system according to claim 1, wherein the control apparatus is configured to receive a velocity variability calculation, to compare this to a variability set point representing the maximum desirable fluctuation, and to control the rate of the adjustable pneumatic gas flow.

3. The pneumatic conveying system according to claim 1, wherein the system is a closed-loop feedback control system.

4. The pneumatic conveying system according to claim 1, wherein the adjustable pneumatic gas flow adjusts the pneumatic gas pressure, and/or velocity within the pipeline, and wherein the adjustable pneumatic gas flow is provided by a pump, a compressor, or a vacuum exhauster.

5. The pneumatic conveying system according to claim 1, wherein the measurement device measures a stability of the bulk material being conveyed by measuring the bulk materials' electric charge and/or velocity fluctuations, or wherein the measurement device is an electrostatic sensor, a capacitance sensor, an audio sensor, or a microwave/electromagnetic Doppler shift sensor.

6. The pneumatic conveying system according to claim 1, wherein the measurement device comprises at least one electrostatic sensor, and wherein the at least one electrostatic sensor comprises a plurality of arc shaped electrodes.

7. The pneumatic conveying system according to claim 6, wherein the plurality of arc shaped electrodes are located on a bottom of the pipeline and/or on a top of the pipeline.

8. The pneumatic conveying system according to claim 6, wherein an arc angle of the arc shaped electrostatic sensors is about 10 to 30 degrees, about 30 to 60 degrees, about 60 to 90 degrees, about 90 to 120 degrees, 110 to 130 degrees, or about 120 to 150 degrees.

9. The pneumatic conveying system according to claim 1, wherein the control apparatus maintains the velocity of the pneumatic gas in the pipeline by continuously analyzing the variability in the particle velocity data, and updating the control output accordingly.

10. The pneumatic conveying system according to claim 1, wherein the control apparatus maintains the velocity of the pneumatic gas in the pipeline within about 1-15%, about 5-15%, or about 5-10% of a minimum conveying velocity, by continuously or intermittently analyzing the variability of particle velocity data, and updating the control output accordingly, or wherein the control apparatus maintains the velocity of the pneumatic gas in the pipeline within about 10% of a minimum conveying velocity, by continuously or intermittently analyzing the variability of particle velocity data, and updating the control output accordingly.

11. The pneumatic conveying system according to claim 1, wherein the system increases the velocity of the pneumatic gas in the pipeline if the measurement device senses any material blockages forming in the pipeline of the bulk material being conveyed by detecting high particle velocity variation, low actual conveying gas, particle velocity, or rising conveying pressure.

12. The pneumatic conveying system according to claim 1, wherein a relative standard deviation (RSD) of the velocity of the bulk material is used by the control apparatus to regulate the rate of the pneumatic gas flow, to maximize energy efficiency.

13. The pneumatic conveying system according to claim 1, further comprising a plurality of measurement devices connected to the pipeline.

14. A feedback control apparatus for a pneumatic conveying system for conveying bulk material, the feedback control apparatus comprising:
a measurement device, configured to be attachable to a pipeline within the pneumatic conveying system, wherein the measurement device is capable of measuring the particle velocity variability of a bulk material being conveyed; and
a control apparatus, configured to receive and analyze the particle velocity variability data from the measurement device, the control apparatus being configured to use the analysis of the particle velocity variability data to control the flowrate of an adjustable pneumatic gas flow.

15. A method of controlling or regulating the rate of a pneumatic conveying gas in a pneumatic conveying system for conveying bulk material, the system comprising a pipeline, an adjustable pneumatic gas flow connected to the pipeline, a control apparatus, and a measurement device, the method comprising:
measuring the particle velocity variability of a bulk material being conveyed in the pipeline using the measurement device, and outputting particle velocity variability data to the control apparatus;
analyzing the particle velocity variability data with the control apparatus; and
using this analysis to regulate the rate of the pneumatic gas flow based on the analysis of the data.

16. The method according to claim 15, wherein measuring the particle velocity variability of the particulate flow involves measuring the velocity of the bulk material being conveyed.

17. The method according to claim 15, wherein the method regulates the pressure and/or velocity of the pneumatic gas flow, based on the analysis of the data.

18. The method according to claim 15, wherein the particle velocity variability of the bulk material being conveyed is measured by measuring the bulk materials' electric charge and/or velocity fluctuations.

19. The method according to claim 15, wherein the method maintains the velocity of the pneumatic gas in the pipeline within about 1-15%, about 5-15% or about 5-10% of a minimum conveying velocity, by continuously or intermittently analyzing the data, and updating the control output accordingly or wherein the method maintains the velocity of the pneumatic gas in the pipeline within about 10% of a minimum conveying velocity, by continuously or intermittently analyzing the data, and updating the control output accordingly.

20. The method according to claim 15, wherein the method increases the velocity of the pneumatic conveying gas in the pipeline if the measurement device senses any material blockages forming in the pipeline of the bulk material being conveyed.
